(19) United States
(12) Patent Application Publication
(10) Pub. No.: US 2019/0073117 A1
(43) Pub. Date: Mar. 7, 2019

(54) VIRTUAL KEYBOARD KEY SELECTIONS BASED ON CONTINUOUS SLIDE GESTURES

(71) Applicant: HEWLETT-PACKARD DEVELOPMENT COMPANY, L.P., Houston, TX (US)

(72) Inventors: Alexander Wayne CLARK, Houston, TX (US); Brandon James LEE HAIST, Houston, TX (US); Kent E. BIGGS, Houston, TX (US)

(73) Assignee: HEWLETT-PACKARD DEVELOPMENT COMPANY, L.P., Houston, TX (US)

(21) Appl. No.: 16/083,810

(22) PCT Filed: Nov. 15, 2016
(86) PCT No.: PCT/US2016/062019

§ 371 Date: Sep. 10, 2018

(51) Int. Cl. G06F 3/0488

(52) U.S. Cl. CPC G06F 3/04883

(57) ABSTRACT

An example electronic device includes a touch-sensitive display and a processor. The processor is to, in response to detecting a set of touches on the touch-sensitive display, cause a virtual keyboard to be displayed on the touch-sensitive display. The processor is also to set distinct areas of the touch-sensitive display corresponding to the set of touches as distinct initial positions. The processor is further to determine a key selection of the virtual keyboard based on a distance of a continuous slide gesture that starts at an initial position of the initial positions and ends at the initial position.

### BACKGROUND

Some electronic devices have integrated physical input devices, such as a physical keyboard. Some electronic devices, such as cell phones and tablet computers, may have limited physical estate to accommodate a physical input device. Thus, virtual input devices may be used.

### BRIEF DESCRIPTION OF THE DRAWINGS

Some examples of the present application are described with respect to the following figures:

FIG. 1 illustrates an electronic device including a virtual keyboard to receive a key selection based on a continuous slide gesture, according to an example;

FIGS. 2A-2B illustrate a virtual keyboard to receive a key selection based on a continuous slide gesture, according to an example;

FIG. 3A illustrates a process of selecting a key of a virtual keyboard based on a continuous slide gesture, according to an example;

FIG. 3B illustrates a process of selecting a key of a virtual keyboard based on a continuous slide gesture, according to another example;

FIG. 3C illustrates a process of selecting a key of a virtual keyboard based on a continuous slide gesture, according to another example;

FIG. 3D illustrates a process of selecting a key of a virtual keyboard based on a continuous slide gesture, according to another example;

FIG. 4 illustrates an electronic device including a virtual keyboard to receive a key selection based on a continuous slide gesture, according to another example; and

FIG. 5 illustrates an electronic device including a virtual keyboard to receive a key selection based on a continuous slide gesture, according to another example.

### DETAILED DESCRIPTION

An example virtual input device may be a virtual keyboard. The virtual keyboard may be shown on a display of an electronic device. However, the virtual keyboard may lack haptic feedback when a key is selected. A user of the virtual keyboard may have to look at the virtual keyboard constantly to ensure the correct key is selected. Thus, ease of using a virtual keyboard is reduced.

Examples described herein provide an approach to select a key of a virtual keyboard based on a continuous slide gesture. For example an electronic device may include a touch-sensitive display and a processor. The processor may, in response to detecting a set of touches on the touch-sensitive display, cause a virtual keyboard to be displayed on the touch-sensitive display. The processor may also set distinct areas of the touch-sensitive display corresponding to the set of touches as distinct initial positions. The processor may further determine a key selection of the virtual keyboard based on a distance of a continuous slide gesture that starts at an initial position of the initial positions and ends at the initial position. In this manner, examples described herein may increase the ease of using a virtual keyboard.

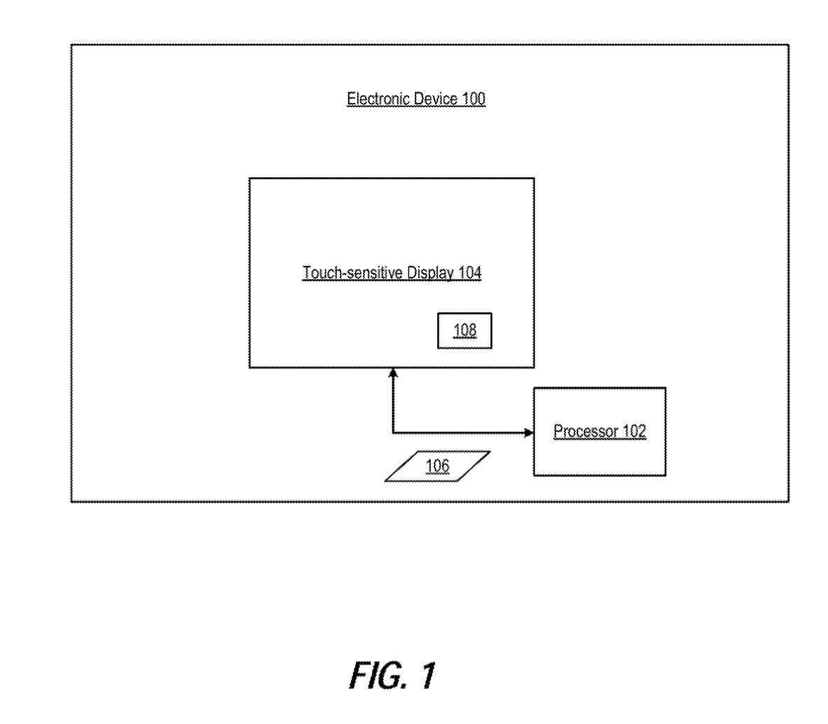

FIG. 1 illustrates an electronic device 100 including a virtual keyboard to receive a key selection based on a continuous slide gesture, according to an example. Electronic device 100, for example, may be a cell phone, a tablet computer, a notebook computer, an all-in-one computer, etc. Electronic device 100 may include a processor 102 and a touch-sensitive display 104. Processor 102 may be a central processing unit (CPU), a semiconductor-based microprocessor, and/or other hardware devices suitable for retrieval and execution of instructions stored in a computer-readable storage medium. Processor 102 may control operations of electronic device 100. Touch-sensitive display 104 may be any type of touchscreen that registers a physical touch. Some examples include resistive touchscreen, capacitive touchscreen, surface acoustic wave touchscreen, etc.

During operation, processor 102 may monitor touches received at touch-sensitive display 104. In response to detecting a set of touches 106 on touch-sensitive display 104, processor 102 may cause a virtual keyboard 108 to be displayed on touch-sensitive display 104. Set of touches 106 may correspond to placements of a user's fingers. Set of touches 106 may be a plurality of touches. In an example, set of touches 106 may include ten distinct touches that correspond to placements of a users ten fingers on touch-sensitive display 104. When virtual keyboard 108 is displayed, keys of virtual keyboard 108 may be displayed based on the placements of the users fingers. Thus, virtual keyboard 108 may be dynamically positioned.

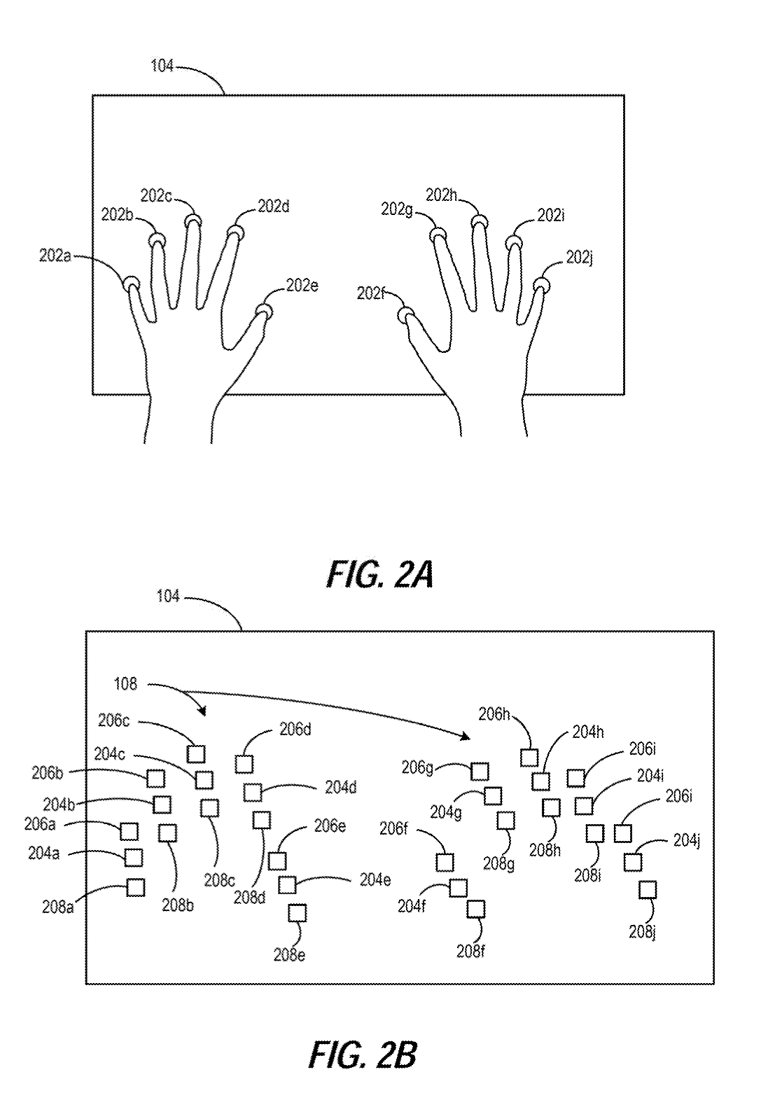

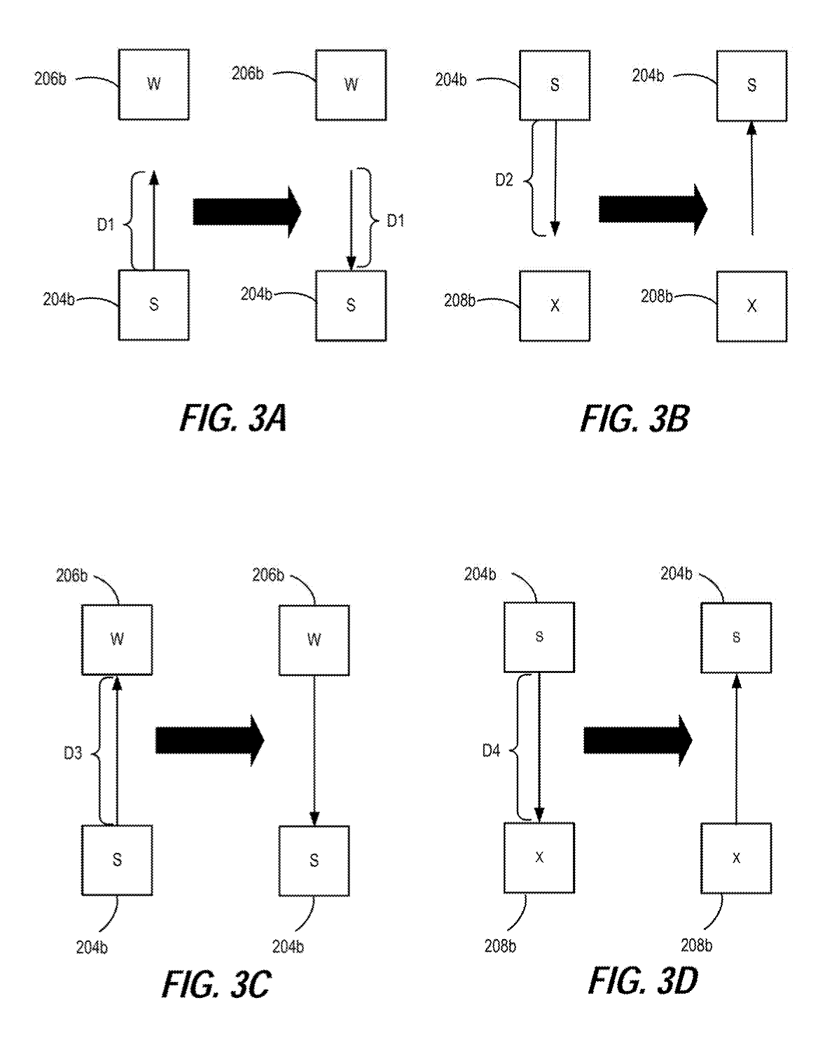

After virtual keyboard 108 is displayed, processor 102 may continue to monitor touches registered by touch-sensitive display 104 to determine key selection(s) of touch-sensitive display 104. Processor 102 may determine a key selection of touch-sensitive display 104 based on a continuous slide gesture as described in more detail in FIGS. 2A-2B and 3A-3C.

FIGS. 2A-2B illustrate virtual keyboard 108 to receive a key selection based on a continuous slide gesture, according to an example. Turning to FIG. 2A. During operation, a user may provide a set of touches to touch-sensitive display 104 by placing ten finger tips on touch-sensitive display 104. Processor 102 may detect the set of touches via touch-sensitive display 104. Processor 102 may set distinct areas 202a-202j of touch-sensitive display 104 corresponding to the set of touches as distinct initial positions. Processor 102 may use the distinct initial positions to determine the positioning of virtual keyboard 108, as described in more detail in FIG. 2B.

Turning to FIG. 2B, for purpose of clarity, the user's hands are not shown. Based on the initial positions, processor 102 may cause virtual keyboard 108 to be displayed on touch-sensitive display 104. Virtual keyboard 108 may include a plurality of sets of keys. For example, virtual keyboard 108 may include a first set of keys 204a-204j, a second set of keys 206a-206j, and a third set of keys 208a-208j. Each distinct key of first set of keys 204a-204j may be displayed at a corresponding initial position. For example, key 2049a may be displayed at area 202a. As another example, key 204b may be displayed at area 202b. Second set of keys 206a-206j may be displayed above first set of keys 204a-204j. Third set of keys 208a-208j may be displayed below first set of keys 204a-204j.

In some examples, virtual keyboard 108 may have a QWERTY layout. In some examples, to access special keys (e.g., numbers, symbols, punctuations, etc.), the user may input a particular gesture (e.g., moving both hands apart) via touch-sensitive display 104 to change virtual keyboard 108 to a second virtual keyboard that has the special keys. In some examples, in response to detecting a removal of the set of touches on touch-sensitive display 104, processor 102 may remove virtual keyboard 108 from touch-sensitive display 104.

FIG. 3A illustrates a process of selecting a key of a virtual keyboard based on a continuous slide gesture, according to an example. Key 204b may represent the character “s”. To select key 204b, the user may perform a continuous slide gesture that starts at an initial position (i.e., area 202b) where key 204b is displayed and ends at the initial position. For example, a finger of the user may be placed at key 204b. The user may slide the finger away from key 204b and towards key 206b for a distance of D1, then the user may slide the finger back to key 204b without lifting the finger from touch-sensitive display 104. Key 204b may not selected until the user's finger has slid back to key 204b. If the user lifts the finger before sliding back to key 204b, the slide gesture is no longer continuous and may be ignored by electronic device 100.

FIG. 3B illustrates a process of selecting a key of a virtual keyboard based on a continuous slide gesture, according to another example. To select key 204b, the user may slide the finger away from key 204b and towards key 208b (representing the character “x”) for a distance of D2, then the user may slide the finger back up to key 204b without lifting the finger from touch-sensitive display 104. In some examples, the distance D2 may be the same as D1. In some examples, the distance D1 may be different from D1.

FIG. 3C illustrates a process of selecting a key of a virtual keyboard based on a continuous slide gesture, according to another example. To select key 206b (representing the character “w”), the user may perform a continuous slide gesture that is different from the continuous slide gesture used to select key 204b. The user may slide the finger away from key 204b and towards key 206b for a distance of D3, then the user may slide the finger back up to key 204b without lifting the finger from touch-sensitive display 104. As illustrated in FIG. 3C, the continuous slide gesture associated with key 206b may have a different direction than the continuous slide gesture associated with key 204b in FIG. 3A. In some examples, the distance D3 may be different from D1 and D2. Thus, the continuous slide gesture associated with key 206b may have a different direction and a different distance than the continuous slide gesture associated with key 204b in FIG. 3A.

FIG. 3D illustrates a process of selecting a key of a virtual keyboard based on a continuous slide gesture, according to another example. To select key 208b (representing the character “x”), the user may perform a continuous slide gesture that is different from the continuous slide gesture used to select key 204b or key 206b. The user may slide the finger away from key 204b and towards key 208b for a distance of D4, then the user may slide the finger back up to key 204b without lifting the finger from touch-sensitive display 104. The distance D4 may be different from D1, D2, and D3.

Processor 102 may determine the key selection based on at least one aspect of a continuous slide gesture that is described in FIGS. 3A-3D. In some examples, processor 102 may determine the key selection based on a distance of the continuous slide gesture. Processor 102 may compare a distance of a continuous slide gesture to a threshold to determine which key is selected. For example, processor 102 may determine that D1 is less than the threshold, thus key 204b is selected. As another example, processor 102 may determine that D3 is greater than the threshold, thus key 206b is selected. In some examples, the distance may be the total distance of the continuous slide gesture. In the example of selecting key 204b, the total distance is two times D1. In some examples, the distance may be the distance of the portion of the continuous slide gesture that is moving away from an initial position. In the example of selecting key 204b, the distance is D1.

In some examples, processor 102 may determine the key selection based on a distance of the continuous slide gesture and a direction of the continuous slide gesture away from an initial position. In the example of selecting key 206b in FIG. 3C, the direction may be upwards towards key 206b and away relative to key 204b. Thus, processor 102 may determine that key 206b is selected as D3 is greater than the threshold and the direction is upwards towards key 206b and away relative to key 204b. In the example of selecting key 208b in FIG. 3D, the direction may be downwards towards key 208b and away relative to key 204b. Thus, processor 102 may determine that key 208b is selected as D4 is greater than the threshold and the direction is downwards towards key 208b and away relative to key 204b.

In some examples, processor 102 may determine the key selection based on a distance of the continuous slide gesture, a direction of the continuous slide gesture away from an initial position, and a character of a key displayed at an initial position. For example, when a continuous slide gesture starts at key 204b, processor 102 may determine that the three potential key selections exist: keys 204b, 206b, and 208b. Processor 102 may use the distance and the direction to determine the key selection from the potential key selections.

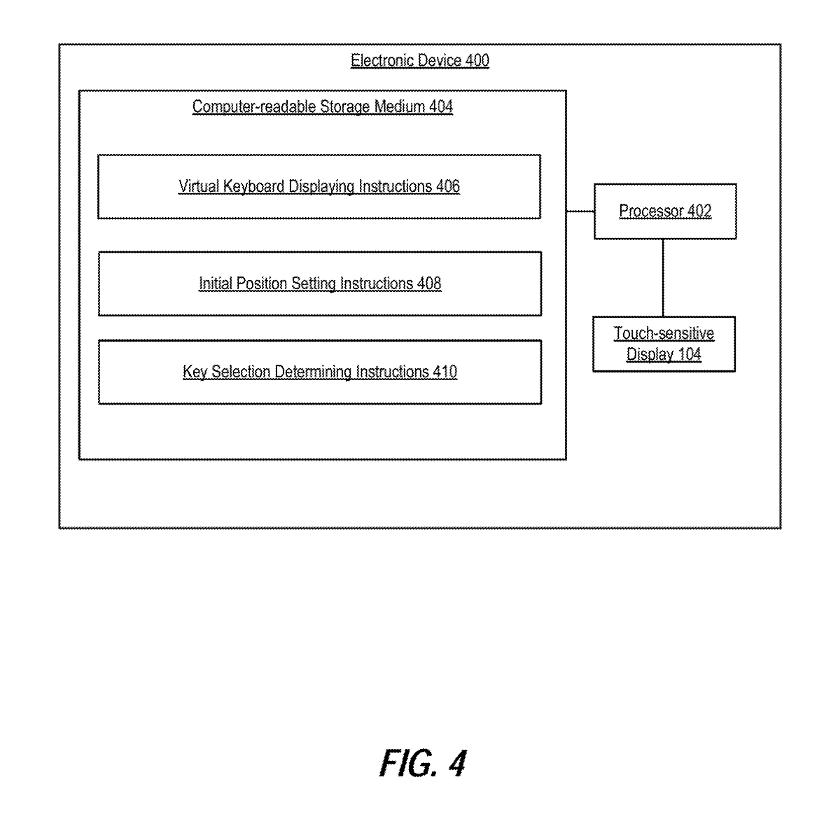

FIG. 4 illustrates an electronic device 400 including a virtual keyboard to receive a key selection based on a continuous slide gesture, according to another example. Electronic device 400 may implement electronic device 100 of FIG. 1. Electronic device 400 may include a processor 402, a computer-readable storage medium 404, and touch-sensitive display 104.

Processor 402 may be a central processing unit (CPU), a semiconductor-based microprocessor, and/or other hardware devices suitable for retrieval and execution of instructions 406-410 stored in computer-readable storage medium 404. Processor 402 may fetch, decode, and execute instructions 406, 408, and 410 to control a process of displaying a virtual keyboard at touch-sensitive display 104 to receive a key selection based on a continuous slide gesture. As an alternative or in addition to retrieving and executing instructions, processor 402 may include at least one electronic circuit that includes electronic components for performing the functionality of instructions 406, 408, 410, or a combination thereof.

Computer-readable storage medium 404 may be any electronic, magnetic, optical, or other physical storage device that contains or stores executable instructions. Thus, computer-readable storage medium 404 may be, for example, Random Access Memory (RAM), an Electrically Erasable Programmable Read-Only Memory (EEPROM), a storage device, an optical disc, etc. In some examples, storage medium 404 may be a non-transitory storage medium, where the term “non-transitory” does not encompass transitory propagating signals.

Virtual keyboard displaying instructions 406 may, in response to detecting a set of touches on touch-sensitive display 104, cause a first set of keys of a virtual keyboard to be displayed at distinct areas of touch-sensitive display 104 corresponding to the set of touches, cause a second set of keys of the virtual keyboard to be displayed above the first set of keys, and cause a third set of keys of the virtual keyboard to be displayed below the first set of keys. For example, referring to FIGS. 2A-2B, processor 102 may detect the set of touches via touch-sensitive display 104. Based on the initial positions, processor 102 may cause virtual keyboard 108 to be displayed on touch-sensitive display 104.

Initial position setting instructions 408 may set initial positions based on the set of touches. For example, referring to FIGS. 2A-2B, processor 102 may detect the set of touches via touch-sensitive display 104. Processor 102 may set distinct areas 202a-202j of touch-sensitive display 104 corresponding to the set of touches as distinct initial positions. Each distinct key of first set of keys 204a-204j may be displayed at a corresponding initial position.

Key selection determining instructions 410 may determine a key selection based on a continuous slide gesture. For example, referring to FIG. 3A, To select key 204b, the user may perform a continuous slide gesture that starts at an initial position (i.e., area 202b) where key 204b is displayed and ends at the initial position. For example, a finger of the user may be placed at key 204b. The user may slide the finger away from key 204b and towards key 206b for a distance of D1, then the user may slide the finger back to key 204b without lifting the finger from touch-sensitive display 104.

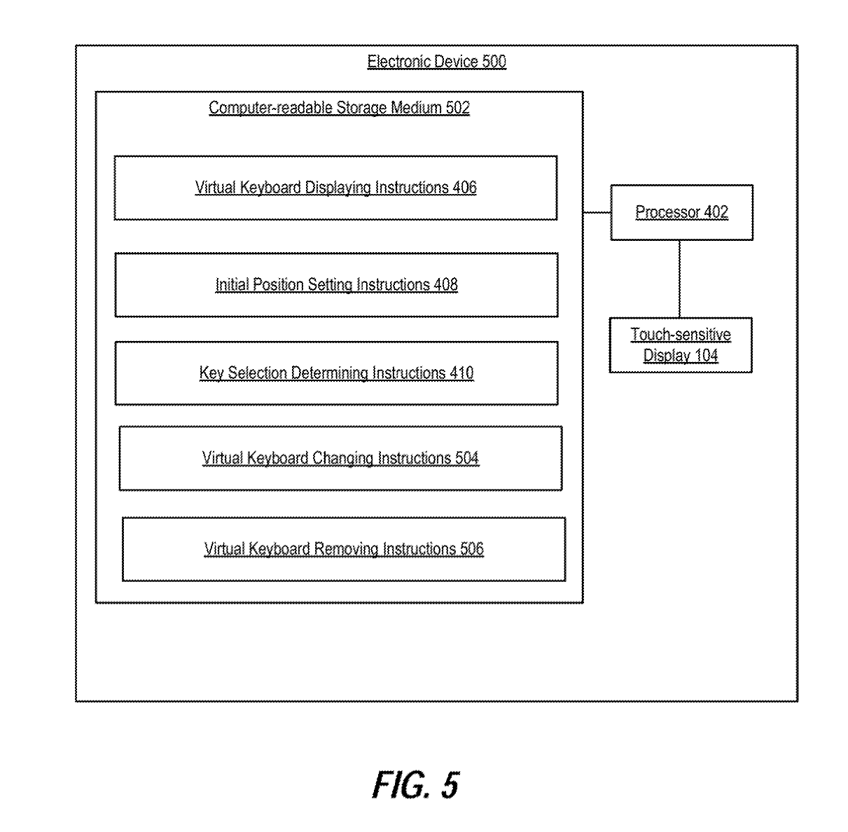

FIG. 5 illustrates an electronic device 500 including a virtual keyboard to receive a key selection based on a continuous slide gesture, according to another example. Electronic device 500 may implement electronic device 100 and/or electronic device 400. Electronic device 500 may include processor 402, a computer-readable storage medium 502 that is similar to computer-readable storage medium 404, and touch-sensitive display 104. Computer-readable storage medium 502 may be encoded with instructions 406-410 and 504-506.

Virtual keyboard changing instructions 504 may change a virtual keyboard displayed on touch-sensitive display 104 to another display based on a gesture input. For example, to access special keys (e.g., numbers, symbols, punctuations, etc.), the user may input a particular gesture (e.g., moving both hands apart) via touch-sensitive display 104 to change virtual keyboard 108 to a second virtual keyboard that has the special keys.

Virtual keyboard removing instructions 506 may remove a virtual keyboard from touch-sensitive display 104. For example, in response to detecting a removal of the set of touches on touch-sensitive display 104, processor 102 may remove virtual keyboard 108 from touch-sensitive display 104.

The use of “comprising”, “including” or “having” are synonymous and variations thereof herein are meant to be inclusive or open-ended and do not exclude additional unrecited elements or method steps.

What is claimed is:

1. An electronic device comprising:
a touch-sensitive display; and
a processor to:
in response to detecting a set of touches on the touch-sensitive display, cause a virtual keyboard to be displayed on the touch-sensitive display;
set distinct areas of the touch-sensitive display corresponding to the set of touches as distinct initial positions; and
determine a key selection of the virtual keyboard based on a distance of a continuous slide gesture that starts at an initial position of the initial positions and ends at the initial position.

2. The electronic device of claim 1, wherein the set of touches includes ten distinct touches.

3. The electronic device of claim 1, wherein the processor is further to determine the key selection based on the distance and based on a character of a key displayed at the initial position.

4. The electronic device of claim 1, wherein the virtual keyboard has a QWERTY layout.

5. An electronic device comprising:
a touch-sensitive display; and
a processor to:
in response to detecting a set of touches on the touch-sensitive display, cause a virtual keyboard to be displayed on the touch-sensitive display;
set distinct areas of the touch-sensitive display corresponding to the set of touches as distinct initial positions; and
determine a key selection of the virtual keyboard based on a distance of a continuous slide gesture that starts at an initial position of the initial positions and ends at the initial position and based on a direction of the continuous slide gesture away from the initial position.

6. The electronic device of claim 5, wherein the processor is to, in response to detecting a particular gesture via the touch-sensitive display, change the virtual keyboard to a second virtual keyboard.

7. The electronic device of claim 5, wherein the processor is to determine the key selection based on the distance, the direction, and a character of a key displayed at the initial position.

8. The electronic device of claim 5, wherein the virtual keyboard has a QWERTY layout.

9. A non-transitory computer readable storage medium comprising instructions that when executed cause a processor of an electronic device to:
in response to detecting a set of touches on a touch-sensitive display of the electronic device:
cause a first set of keys of a virtual keyboard to be displayed at distinct areas of the touch-sensitive display corresponding to the set of touches;
cause a second set of keys of the virtual keyboard to be displayed above the first set of keys; and
cause a third set of keys of the virtual keyboard to be displayed below the first set of keys;
set each key of the first set of keys as a distinct initial position; and
determine a key selection of the virtual keyboard based on a distance of a continuous slide gesture that starts at an initial position and ends at the initial position.

10. The non-transitory computer readable storage medium of claim 9, wherein a key selection of the first set of keys is associated with a first distance, and wherein a key selection of the second set of keys is associated with a second distance different from the first distance.

11. The non-transitory computer readable storage medium of claim 9, wherein a continuous slide gesture associated with a key selection of the second set of keys has a different direction than a continuous slide gesture associated with a key selection of the third set of keys.

12. The non-transitory computer readable storage medium of claim 9, wherein the virtual keyboard has a QWERTY layout.

13. The non-transitory computer readable storage medium of claim 9, wherein the instructions when executed further cause the processor to, in response to detecting a particular gesture via the touch-sensitive display, change the virtual keyboard to a second virtual keyboard.

14. The non-transitory computer readable storage medium of claim 13, wherein the particular gesture is different from a gesture associated with a key selection of the first set of keys, the second set of keys, or the third set of keys.

15. The non-transitory computer readable storage medium of claim 9, wherein the instructions when executed further cause the processor to, in response to detecting a removal of the set of touches on the touch-sensitive display, remove the virtual keyboard from the touch-sensitive display.
